(19) United States
(12) Patent Application Publication
(10) Pub. No.: US 2008/0277361 A1
(43) Pub. Date: Nov. 13, 2008

(54) Dispenser with LED Lighting

(75) Inventor: Guy Primiano, Alpharetta, GA (US)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 11/745,005

(22) Filed: May 7, 2007

(51) Int. Cl. A47F 7/00; F21V 9/00

(52) U.S. Cl. 211/49.1; 362/363

(57) ABSTRACT

An enclosure for displaying a number of items. The enclosure may include a first product shelf, a second product shelf, and one or more light emitting diodes positioned about the first product shelf and directed towards the second product shelf.

### TECHNICAL FIELD

The present application relates generally to dispensers and more particularly relates to LED lighting schemes and LED positioning within a dispenser such as a cooler, a vender, and the like.

### BACKGROUND OF THE INVENTION

Product dispensers may take many different shapes and sizes. Each dispenser generally requires some sort of product illumination and/or signage illumination. Traditionally, white florescent lighting has been used. Such florescent lighting, however, often leaves portions of the dispenser inadequately illuminated. Moreover, such florescent lighting has a limited lifespan. A dimly lit dispenser or a dispenser with a burned out lighting source may give a consumer at least the perception that the products therein are not adequately chilled.

Due to the increased lifetime and decreased power usage, light emitting diode (“LED”) lighting is becoming common in many lighting applications. As such, current LED lighting issues generally focus on the ease of LED installation, the ease of modifications, and overall reduced costs. For example, known LED lighting systems can be difficult to install or modify given that a flexible power harness generally is used. Furthermore, these LED issues generally need to be addressed in the context of adequate product marketing, i.e., the dispenser and the products therein should be illuminated so as to be visually appealing and catch the eye of the consumer.

There is a desire, therefore, for a dispenser with an improved LED lighting scheme. This improved lighting scheme should be easy to install, modify, and be reasonable in terms of cost while still providing superior illumination and product marketing.

### SUMMARY OF THE INVENTION

The present application thus describes an enclosure for displaying a number of items. The enclosure may include a first product shelf, a second product shelf, and one or more light emitting diodes positioned about the first product shelf and directed towards the second product shelf.

The first product shelf may include a number of product rails and a number of support rails. The product rails may include a number of solid rails. The product rails may include a number of upwardly angled ends alternating with a number of downwardly angled ends. The alternating angled ends may include a void there between with the light emitting diodes positioned therein. The product rails may include an angled extension with the light emitting diodes positioned thereon.

The product rails may include a number of hollow product rails. The hollow product rails may include the light emitting diodes positioned therein. The support rails may include a number of hollow support rails. The hollow support rails may include the light emitting diodes positioned therein. The enclosure further may include an electrical system and the first product shelf and the light emitting diodes may be in communication with the electrical system.

The application further describes an enclosure for displaying a number of different types of products. The enclosure may include a first product shelf with a first type of product thereon and one or more first light emitting diodes of a first wavelength and a second product shelf with a second type of product thereon and one or more second light emitting diodes of a second wavelength.

The first light emitting diodes and the second light emitting diodes may include one or more tri-color light emitting diodes. The enclosure further may include a third product shelf with one or more third light emitting diodes of a third wavelength. The first wavelength may include an ultraviolet light and the second wavelength may include a colored light.

The present application further describes an enclosure for displaying a number of items. The enclosure may include a cabinet, a door, one or more light emitting diodes extending vertically about a first side of the door, and a reflector positioned about the light emitting diodes so as to reflect the light from the light emitting diodes into the cabinet.

The light emitting diodes and the reflector may extend the length of the door. The light emitting diodes may be mounted on the door and the reflector may be mounted within the cabinet. The reflector reflects light from the light emitting diodes into the cabinet when the door is closed. The light emitting diodes directly illuminate one or more of the items when the door is open.

These and other features of the present application will become apparent to one of ordinary skill in the art upon review of the following detailed description when taken in conjunction with the appended claims and the several drawings.

### BRIEF DESCRIPTION OF THE DRAWINGS

FIG. 1 is a perspective view of a known cooler.

FIG. 2 is a front plan view of an interior section of a cooler as is described herein.

FIG. 3 is a top plan view of a product shelf as is described herein

FIG. 4 is a side plan view of the product shelf of FIG. 3.

FIG. 5 is a top plan view of an alternative embodiment of a product shelf as is described herein.

FIG. 6 is a side plan view of the product shelf of FIG. 5.

FIG. 7 is a top plan view of an alternative embodiment of a product shelf as is described herein.

FIG. 8 is a top plan view of an alternative embodiment of a product shelf as is described herein.

FIG. 9 is a front plan view of an alternative embodiment of a cooler as is described herein.

FIG. 10 is a perspective view of a tri-color light emitting diode as is described herein.

FIG. 11 is a perspective view of an alternative embodiment of a cooler as is described herein.

FIG. 12 is a top cross-sectional view of the cooler of FIG. 11.

### DETAILED DESCRIPTION

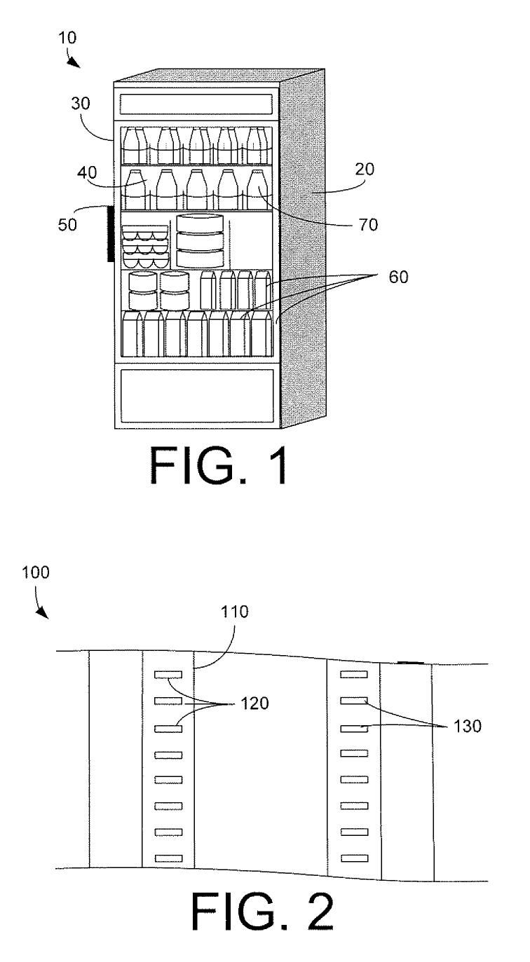

Referring now to the drawings, in which like numerals refer to like elements throughout the several views, FIG. 1 shows a known dispenser 10. As described above, the dispenser 10 may take many different forms. As such, the term “dispenser” includes, but is not limited to, vending machines, coolers, refrigerators, or any other type of enclosure for storing and/or displaying products or other types of items. A dispenser generally includes a cabinet 20 with one or more front doors 30. The front door 30 may have a transparent panel 40 thereon so as to see within the cabinet 20. The dispenser 10 may have a handle 50 so as to open the front door 30 or the dispenser 10 may have a selection device, a product port, and a payment device if used as a vending machine.

The dispenser may have any number of product shelves 60 positioned therein. The product shelves 60 may take any shape or size. A number of products 70 may be positioned on the product shelves 60. The products 70 may take any form. A number of beverage containers and other types of products are shown. The dispenser 10 may be refrigerated, heated, left at ambient temperature, or have a number of zones with different temperatures.

FIG. 2 shows a portion of a dispenser 100 as is described herein. The dispenser 100 may be largely similar to the dispenser 10 described above. As is shown, the dispenser 100 may include a number of adjustment rails 110 positioned therein. The adjustment rails 110 may be positioned on the rear, the sides, or both of the cabinet 20. The adjustment rails 110 may include a number of rail slots 120 therein. The rail slots 120 allow the product shelves 60 to be positioned as desired. The product shelves 60 may be positioned therein directly or clips or other types of connectors may be used. The dispenser 100 also includes at least one power bus 130. The power bus 130 is positioned within the cabinet 20. Any type of power source may be used hereon. The power bus 130 may be in electrical communication with the rail slots 120 of the adjustment rails 110.

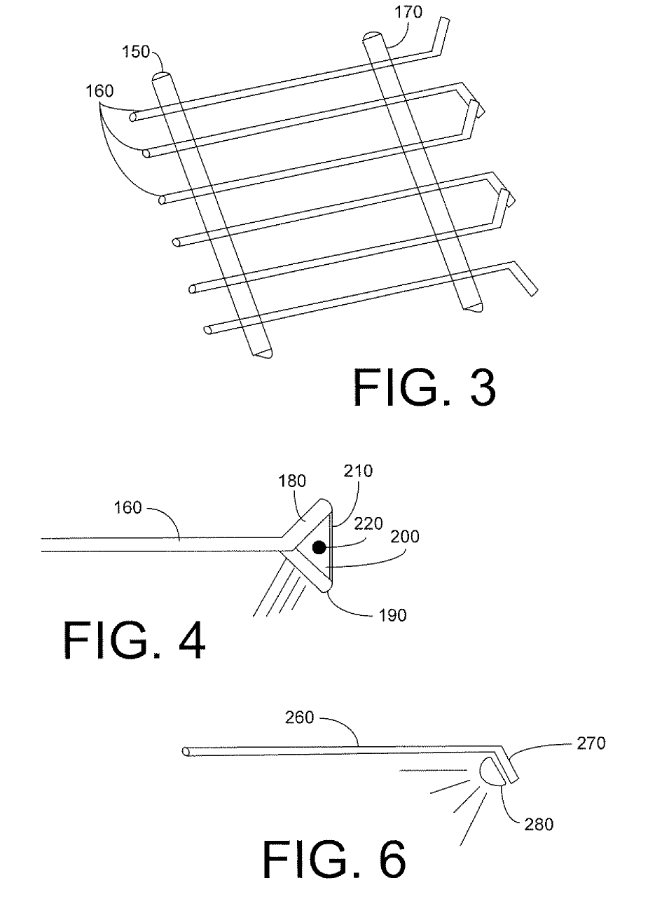

FIGS. 3 and 4 show a product shelf 150 as is described herein for use with the dispenser 100. The product shelf 150 includes a number of product rails 160 and support rails 170. The product rails 160 generally extend from the rear of the cabinet 20 towards the front door 30. The support rails 160 extend in a perpendicular relationship and support the product rails 160. Any other configuration may be used herein.

A number of the product rails 160 may have an upwardly angled end and, alternately, a number of the product rails 160 may have a downwardly angled end 190. The alternating upwardly and downwardly angled ends 180, 190 form a substantially triangular shape void 200. A cover 210 may extends across the void 200. The cover 210 may be a substantially flat band that extends across the void 200 or across all or part of the width of the product shelf 150. One or more LED's 220 may be positioned underneath the cover 210 within some or all of the voids 200. The cover 210 shields the consumer from any glare from the LED's 220. The cover 210 may have a reflective surface positioned about the LED's 220. The LED's 220 are positioned downwards such that the light is directed toward the products 70 on the product shelf 150 below.

Some or all of the product rails 160 may be solid. Several of the product rails 160 may be positioned within the rail slots 120 and supported thereby such that the product rails 160 may be in communication with the power bus 130. Those product rails 160 may be properly insulated and in communication with one or more of the LED's 220. The LED's 220 along the other product rails 160 then may be wired together. Alternatively, the product rails 160 may be hollow and the LED's 220 may be in communication with the power bus 130 via wiring within the rails 160. Combinations of hollow and solid product rails 160 also may be used. Other forms of powering the LED's 220 also may be used. The use of a power harness as is typically used thus may be avoided.

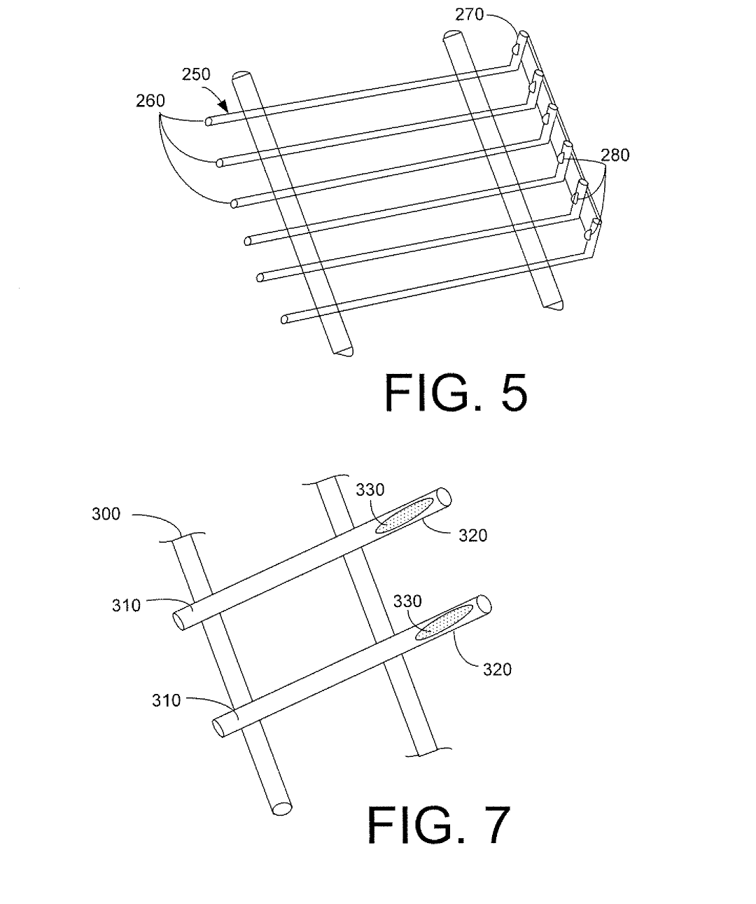

FIGS. 5 and 6 show a further embodiment of a product shelf 250. The product shelf 250 has a number of solid product rails 260. In this embodiment, the product rails 260 may have an angled extension 270 that extends from some or all of the product rails 260. The angled extension 270 extends from each product rail 260 and then angles downwardly. One or more LED's 280 may then be positioned on or in the angled extension 270. A cover 290 or other type of connection may extend across the product rails 260 and connect the LED's 280. The LED's also may be attached to the cover 290. The LED's 280 may be powered as described above or any other convenient fashion.

FIG. 7 shows a further embodiment of a product shelf 300. In this embodiment, the product shelf 300 includes a number of hollow product rails 310. One or more LED's 320 may be positioned within each of the hollow rails 310. Any number of LED's may be used. Each LED 320 may have a transparent cover 330 positioned thereon. The LED's 320 may be positioned along the length of the product rail 310 as desired. The LED's 320 may be positioned in all or some of the hollow product rails 310. The LED's may be powered as described above or in any other convenient fashion.

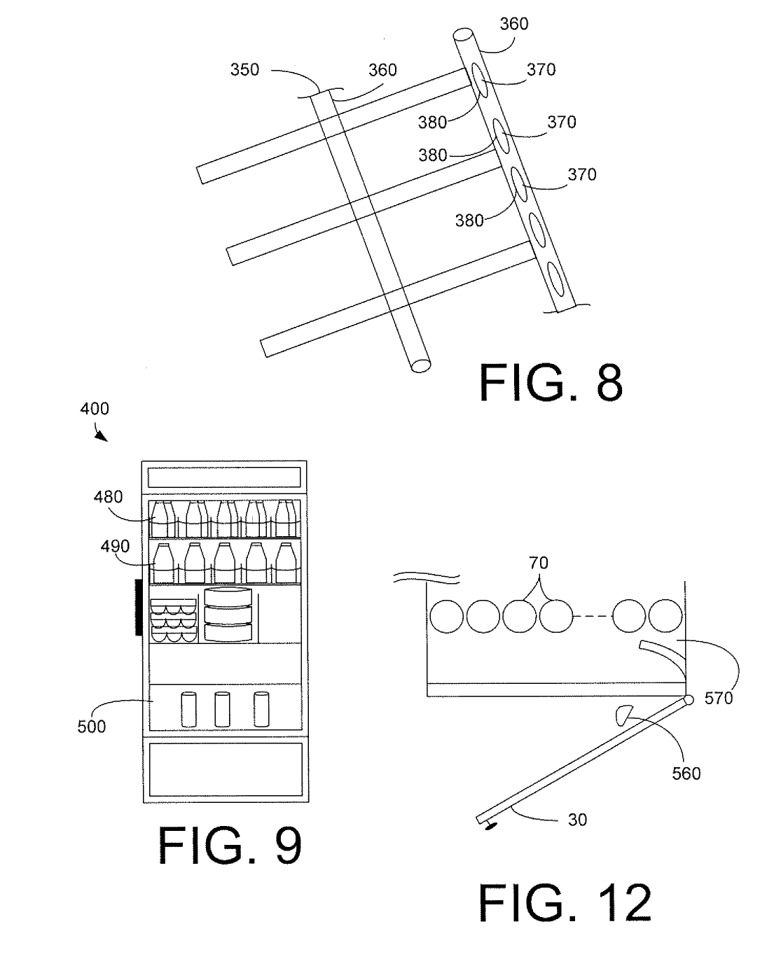

FIG. 8 shows a further embodiment of a product shelf 350. In this embodiment, the product shelf 350 includes a number of hollow support rails 360. One or more LED's 370 may be positioned within the support rails 360. Any number of LED's may be used. The LED's 370 may be enclosed by a transparent cover 380. The LED's 370 may be positioned in all or some of the support rails 360. The LED's may be powered as described above or in any other convenient fashion.

In use, the product shelves 150, 250, 300, 350 provide for the direct illumination of one or more products 70 positioned below. The front product 70 on each product shelf 150, 250, 300, 350 may be illuminated or any or all of the products 70 may be illuminated. Because each product shelf 150, 250, 300, 350 is in direct communication with the power bus 130, the positioning of the shelves 150, 250, 300, 350 may be easily modified as desired. Combinations of these alternative product shelf embodiments may be used together. Conventional lighting also may be used herein.

FIGS. 9 and 10 show a further embodiment of a dispenser 400. The dispenser 400 may include a number of product shelves such as the product shelves 150, 250, 300, 350 described above. Any other type of product shelf 60 also may be used herein. The product shelves 60, 150, 250, 300, 350 may include one or more tri-color LED's 410. As is shown in FIG. 10, each tri-color LED 410 may include a first anode 420 producing light of a first wavelength, a second anode 430 producing light with a second wavelength, and a third anode 440 producing light with a third wavelength. The tri-color LED 410 also may have a common cathode 450. The anodes 420, 430, 440 are positioned within a common housing 460 and enclosed by a lens 470. In this example, the first wavelength 420 may be an ultraviolet light while the second and third wavelengths may be a colored light. Any desired wavelength may be used herein.

The dispenser 400 may have a number of product zones. In this example, three product zones are used, a first product zone 480, a second product zone 490, and a third product zone 500. Particular types of products 70 may be positioned within each product zone. For example, the first product zone 480 may include “health” products, the second product zone 490 may include “wellness” products, and the third product zone 500 may include metallic packages. The LED's 410 in each product zone 480, 490, 500 may emit a particular, distinct wavelength. For example, the “health” products in the first product zone 480 may have LED's 410 emitting light at a 530 nm or higher. The metallic products of the third product zone 500 may have an ultraviolet wavelength.

The use of a consistent color and wavelength with respect to certain types of products will help to distinguish those products 70 while also reinforcing the nature of the products, i.e., “health,” “wellness,” etc. Such a consistent color also can become a unique identification of source and origin for the products. The use of the three wavelengths within a single LED 410 optimizes the light distributing qualities while minimizing costs. The LED's 410 could be used in combination. Conventional lighting also may be used. The LED's 410 may be die formed or pre-mounted in some manner. Any number of product zones and light wavelengths may be used herein.

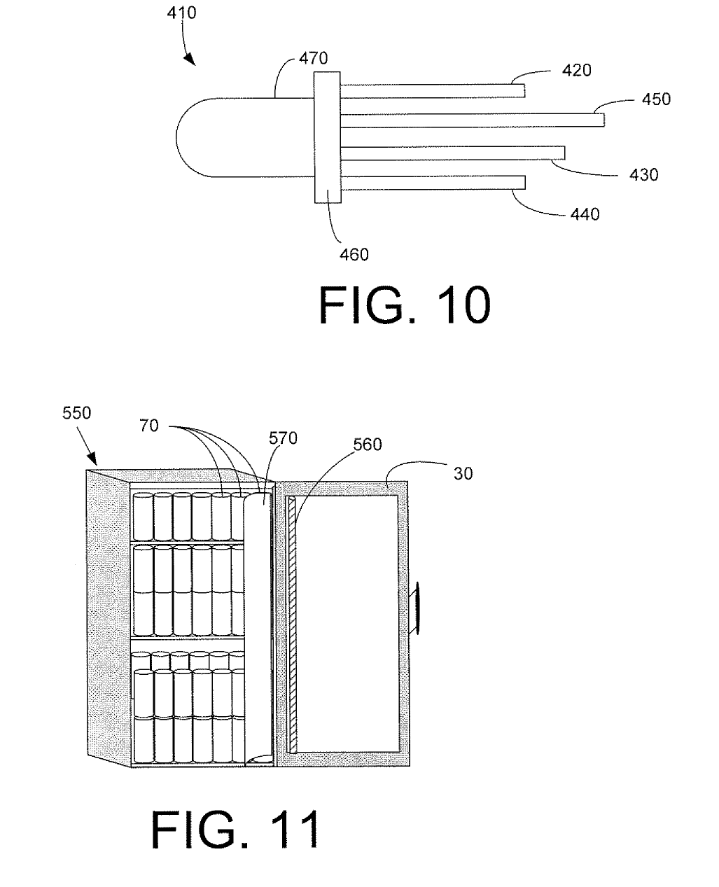

FIGS. 11 and 12 show a further embodiment of a dispenser 550. The dispenser 550 may be similar to the dispenser 10 described above but with a vertical LED array 560 mounted to the door 30 of the dispenser 550. The vertical LED array 560 may extend the length of the door 30. The vertical LED array 560 may be directed somewhat towards a sidewall of the cabinet 20. A reflector 570 may be positioned within the enclosure 30 about the vertical LED array 560. The reflector 570 may reflect the light from the vertical LED array towards the products 70. The reflector 570 also may defuse the light somewhat. The reflector 570 may extend the length of the vertical LED array 560. The reflector 570 may include a reflective surface thereon.

When the door 30 of the dispenser 550 is closed, the reflector 570 reflects the light of the vertical LED array 560 towards the products 70. When the door 30 is opened, the vertical LED array 560 directly illuminates the products 70. The light from the vertical LED array 560 will pass over the products 70 as the door 30 is opened so as to illuminate the products 70 as a whole or individually in a sweeping action. The products 70 thus are illuminated at all times while eliminating or reducing any glare to consumers.

It should be apparent that the foregoing relates only to the preferred embodiments of the present application and that numerous changes and modifications may be made herein by one of ordinary skill in the art without departing from the general spirit and scope of the invention as defined by the following claims and the equivalents thereof.

1. (canceled)

2. (canceled)

3. The enclosure of claim 4, wherein the plurality of product rails comprises a plurality of solid rails.

4. An enclosure for displaying a number of items, comprising:
a first product shelf;
wherein the first product shelf comprises a plurality of product rails;
a second product shelf; and
one or more light emitting diodes positioned about the first product shelf and directed towards the second product shelf;
wherein the plurality of product rails comprises a plurality of upwardly angled ends alternating with a plurality of downwardly angled ends.

5. The enclosure of claim 4, wherein the plurality of upwardly angled ends alternating with the plurality of downwardly angled ends comprises a void therebetween and wherein the one or more light emitting diodes are positioned therein.

6. An enclosure for displaying a number of items, comprising:
a first product shelf;
wherein the first product shelf comprises a plurality of product rails;
a second product shelf; and
one or more light emitting diodes positioned about the first product shelf and directed towards the second product shelf;
wherein one or more of the plurality of product rails comprise an angled extension and wherein the one or more light emitting diodes are positioned thereon.

7. (canceled)

8. An enclosure for displaying a number of items, comprising:
a first product shelf;
wherein the first product shelf comprises a plurality of hollow product rails;
a second product shelf; and
one or more light emitting diodes positioned about the first product shelf and directed towards the second product shelf;
wherein one or more of the plurality of hollow product rails comprises the one or more light emitting diodes positioned therein.

9. (canceled)

10. The enclosure of claim 8,
wherein the first product shelf comprises a plurality of hollow support rails; and
wherein one or more of the plurality of hollow support rails comprises the one or more light emitting diodes positioned therein.

11. The enclosure of claim 4, further comprising an electrical system and wherein the first product shelf and the one or more light emitting diodes are in communication with the electrical system.

12. An enclosure for displaying a number of different types of products, comprising:
a first product shelf with a first type of product thereon;
one or more first light emitting diodes positioned about the first product shelf;
the one or more first light emitting diodes comprising a first wavelength;
a second product shelf with a second type of product thereon; and
one or more second light emitting diodes positioned about the second product shelf;
the one or more second light emitting diodes comprising a second wavelength.

13. The enclosure of claim 12, wherein the one or more first light emitting diodes and the one or more second light emitting diodes comprise one or more tri-color light emitting diodes.

14. The enclosure of claim 12, further comprising:
a third product shelf; and
one or more third light emitting diodes positioned about the third product shelf;
the one or more third light emitting diodes comprising a third wavelength.

15. The enclosure of claim 12, wherein the first wavelength comprises an ultraviolet light and the second wavelength comprises a colored light.

16. An enclosure for displaying a number of items, comprising:
a cabinet;
the cabinet enclosed by a door;
one or more light emitting diodes extending vertically about a first side of the door; and
a reflector positioned about the one or more light emitting diodes to reflect the light from the one or more light emitting diodes into the cabinet.

17. The enclosure of claim 16, wherein the one or more light emitting diodes and the reflector extend the length of the door.

18. The enclosure of claim 16, wherein the one or more light emitting diodes are mounted on the door and the reflector is mounted within the cabinet.

19. The enclosure of claim 16, wherein the reflector reflects light from the one or more light emitting diodes into the cabinet when the door is closed.

20. The enclosure of claim 19, wherein the one or more light emitting diodes directly illuminate one or more of the number of items when the door is open.
